(19) United States
(12) Patent Application Publication
(10) Pub. No.: US 2013/0011257 A1
(43) Pub. Date: Jan. 10, 2013

(54) POWER GENERATING APPARATUS AND METHOD

(75) Inventor: Robert Lim, Saltney (GB)

(73) Assignee: Relentless Power Limited, Ebbw Vale, South Wales (GB)

(21) Appl. No.: 13/635,852

(22) PCT Filed: Mar. 18, 2011
(86) PCT No.: PCT/GB2011/000392

§ 371 Date: Sep. 18, 2012

(30) Foreign Application Priority Data
Mar. 19, 2010 (GB) 1004654.8

(51) Int. Cl. F03B 1/02

(52) U.S. Cl. 416/1; 416/197 R

(57) ABSTRACT

A method is provided for generating power comprising the steps of:
(i) Providing a rotor (3, 508, 602, 702, 802, 902, 1002), at least part of which is immersed in a liquid; and
(ii) Passing gas through the liquid and into contact with the rotor, the gas causing the rotor to rotate.

The present invention relates to a method and apparatus for generating power, particularly, but not exclusively, a method and apparatus for generating power at least partially using tidal or wave power.

There is an increasing demand for ways of generating power (typically in the form of electrical power) from “green” or renewable sources. The present invention provides an apparatus and method for generating power from many types of so-called “green” energy.

In accordance with a first aspect of the present invention, there is provided an apparatus to generate power from a gas, the apparatus comprising:

a rotor for at least partial immersion in a liquid,

the rotor being provided with a plurality of pockets for receiving gas, the rotor being operable to be rotated by the gas received in one or more of said pockets.

The apparatus may comprise a means for supplying gas to said rotor. The means for supplying gas may comprise one or more of: a container for the storage of gas, optionally at a pressure of greater than 1 atmosphere; a container for the storage of liquid, and optionally a means for heating the liquid to form a gas; a valve operable to introduce gas to the rotor, and a gas pump. For example, the means for supplying gas may comprise a gas pump which may deliver gas to the rotor without storage of the gas. Alternatively, the means for supplying gas may comprise a gas pump operable to supply gas to a container for the storage of gas. Gas stored in the container may then be released to the rotor.

The gas pump (if present) may be operable by movement of said liquid. For example, the gas pump (if present) may comprise one or more cavities which, in use, are at least partially filled with a liquid, the introduction of liquid into said cavity displacing gas out of said cavity towards the rotor. The apparatus may be provided with one or more non-return valves which permit gas to enter a cavity but inhibit egress of gas from a cavity through the non-return valve. A non-return valve therefore permits a cavity to be refilled with gas. It is preferred that the gas pump comprises a plurality of such cavities, each of said cavities being associated with a non-return valve.

The gas pump (if present) may comprise a compressor.

The gas pump may be operably associated with an actuator for actuating the pump. Movement of the actuator may actuate the gas pump. The actuator may, for example, comprise said rotor. Rotation of the rotor (for example, as a result of liquid flow) may actuate operation of the gas pump. The actuator may comprise one or more floats. Movement of the one or more floats (for example, lifting caused by the passage of a wave) may actuate operation of the gas pump.

The gas pump (if present) may be operably associated with one or more floats, the one or more floats being movable between a first floats position and a second floats position, movement of the float from said first floats position to said second floats position causing said pump to expel gas (optionally to a container for the storage of gas, if present). The one or more floats may be pivotally attached to an apparatus main body, the one or more floats being pivotally movable between the first floats position and the second floats position.

The means for heating the liquid to form a gas (if present) may comprise a conductive member operable to be heated by a heat source. The heat source may comprise one or more reflective surfaces arranged to direct radiation to the conductive member.

The valve operable to introduce gas to the rotor may be operable by a pressure differential across the valve. For example, operation of the valve to introduce gas to the rotor may take place if the pressure in an enclosure housing the rotor is less than ambient pressure.

If the apparatus comprises a container for the storage of gas, the apparatus may be provided with a pressure limiter associated with the container to limit the pressure in the container. The pressure limiter may be operable to limit the maximum pressure in the container as required, and may optionally be operable to limit the maximum pressure in the container to less than about 10, preferably less than about 5 atmospheres, more preferably less than about 3 atmospheres and further more preferably to about 2 atmospheres.

At least one (optionally more than one, further optionally a majority of and further more optionally each) pocket may be formed by one or more rotor blades, optionally in combination with a further surface of the rotor. For example, a blade may project from a rotor hub. Adjacent blades, in combination with a surface of the hub adjacent to said blades, may form a pocket. In this case, the blades may extend radially away from the hub.

Alternatively, for example, at least one (optionally more than one, further optionally a majority of and further more optionally each) blade may extend between two end plates, the end plates and the blade forming a pocket. The end plates for a blade may be provided individually i.e. a blade may be provided with end plates which are distinct from the end plates provided on other blades. Alternatively, the rotor itself may be provided with two rotor end plates, the blades extending between the two rotor end plates. In this case, the two rotor end plates act as end plates for each blade.

The shape of each of the pockets is not limited to any particular shape, the important feature of the pocket being that it is shape allows it to collect gas. At least one (optionally more than one, further optionally a majority of and further more optionally each) blade may be elongate. At least one (optionally more than one, further optionally a majority of and further more optionally each) blade may be concave. At least one (optionally more than one, further optionally a majority of and further more optionally each) blade may be hemi-cylindrical. One or more of said pockets may be defined by a conical or frusto-conical surface.

The rotor may be provided with from 3 to 10 pockets, preferably from 4 to 9 pockets, more preferably from 5 to 8 pockets and further more preferably 7 or 8 pockets. It has been found that 7 pockets have proved to be most effective.

The rotor may be arranged so that, in the event that a pocket becomes over-full with gas, at least some of the gas leaving said pocket is received by a different pocket, typically a pocket located above the overfull pocket. In this manner, gas may collect in more than one pocket, thereby providing improved turning torque. This is particularly advantageous when the rotor is initially at rest (and therefore static inertia is high).

At any given point in time, one or more (but not all) of the pockets may be in a position to receive gas.

The apparatus is typically arranged so that gas rises into a pocket by virtue of the natural buoyancy of the gas (as opposed to the velocity of the gas). The accumulation of gas in one or more of said pockets may cause initial rotation of the rotor. Once rotation of the rotor has started, gas released from the outlet keeps the rotor rotating. The gas is typically released from a pocket after the upwards motion of the pocket associated with rotor rotation has been completed.

The apparatus may be operable in a first operating condition for generating power which optionally comprises rotation of the pocket-carrying rotor and a second operating condition for generating power in which the pocket-carrying rotor is rotated by gas delivered to the pocket-carrying rotor. The apparatus would typically operate in one, but not both, of the first and second operating conditions at any given moment in time.

References to the pocket-carrying rotor are made to distinguish that rotor from any other rotors which may be provided as part of the apparatus.

If the pocket-carrying rotor is operable to rotate in the first operating condition, then such rotation may be caused by a flow of liquid, such as tidal flow, or flow of liquid under the influence of gravity.

The apparatus may be provided with a primary power-generating actuator for generating power in the first operating condition. Examples of primary power-generating actuators include a wind-actuated rotor and a float. The float may form part of a mechanism for generating power using wave motion. If the apparatus is provided with a primary power-generating actuator, the pocket-carrying rotor may not (and preferably does not) rotate in the first operating condition.

The apparatus may be arranged so that in the absence of sufficient stimulus for operation in the first operating condition (for example, in light winds, poor wave conditions or on a tidal slack water), the apparatus is arranged to operate in the second operating condition.

Operation in the first operating condition may urge gas into a container for the storage of gas. The apparatus may be provided with a compressor for urging gas into the contained for the storage of gas. The gas so stored may then be released to cause rotation of the pocket-carrying rotor.

The apparatus may comprise a floating platform. The rotor carrier (if present) may be pivotally mounted to the floating platform. The floating platform may support the container (if present), for example. The container may be in the form of a hull of a boat, in particular a catamaran.

The apparatus may be provided with a gas outlet for emission of the gas into the liquid. The gas outlet may be located to one side of the axis of rotation of the rotor. Location of the outlet immediately beneath the axis of the rotor could lead to non-rotation of the rotor. It is preferred that the outlet is arranged to emit bubbles of gas into said pockets.

In use, the outlet may be located beneath the rotor.

The apparatus may be operable in a first operating condition in which the pocket-carrying rotor is, in use, rotated by a flow of liquid and a second operating condition in which, in use, the pocket-carrying rotor is rotated by gas delivered to the pocket-carrying rotor. The apparatus would typically operate in one of the first and second operating conditions at any given moment in time. The flow of liquid may, for example, be a tidal flow.

Such an apparatus provides rotation of the rotor when a tide is flowing (as a result of the rotor being rotated by the moving water) and rotation of the rotor when the tide is not flowing (as a result of the gas delivered to the rotor). An alternative tidal-driven apparatus will operate by the tide filling an upper container with water, the water then being released under the effect of gravity to spin the rotor. A second, lower container may, in use, contain pressurised gas which may be used to rotate the rotor when the rotor is not being driven by water.

A tidal-driven apparatus will typically comprise a container for the storage of gas. The apparatus may be provided with a gas compressor for delivering gas to the container, the gas compressor being operable in response to rotation of the rotor in the first operation condition (i.e. rotation of the rotor resulting from liquid, as opposed to gas, flow).

The apparatus may be arranged such that in the absence of a tidal flow of a given magnitude, the apparatus is arranged to operate in the second operating condition.

This may be achieved, for example, by providing a rotor which in the absence of a tidal flow of a given magnitude assumes a certain position or orientation, the assumption of that certain position or orientation actuating release of gas from the container.

The rotor may be attached to a rotor carrier and the rotor carrier may be mounted so that movement of the rotor carrier into a particular position actuates release of gas from the container. For example, the rotor carrier may be pivotally mounted. Movement of the rotor carrier into a particular position for actuating the release of gas may be caused by the tidal flow falling below a particular magnitude. The rotor carrier may be pivotally mounted to a floating platform. The rotor carrier may be provided with a fin operable to lift the rotor carrier in the liquid when exposed to a flow of liquid. The rotor carrier may be provided with one or more inflatable and deflatable rotor carrier floats. The one or more floats are typically provided with one or more flow-actuated valves, operable to admit gas into said floats in the event that the flow rate through or past the one or more flow-actuated valves is greater than a pre-determined value.

The apparatus may be provided with a heater for heating gas prior to it being delivered to the rotor The heater may comprise a reflective surface for reflecting radiation onto the gas. The apparatus may comprise a convoluted conduit for the passage therethrough of gas (akin to a car radiator, or other heat exchanger), the heater being arranged to heat the gas in the convoluted conduit.

If the apparatus comprises a container for the storage of gas, the container may comprise a vessel with an open end and a closed end, the open end of which is, in use, located beneath the closed end, the container being used to contain air which is pressurised by the liquid surrounding the container. Such a container is useful in tidal regions where the depth of the water changes dramatically over time. In such a case, the open end of the container is located above the highest low water mark, to allow ingress of air into the container (the air subsequently being pressurised by the rising water level).

The apparatus of the present invention may comprise a wind-actuated rotor which is operable so that rotation of the wind-actuated rotor generates power, typically be causing the operation of an electrical generator. The wind-actuated rotor may be operable so that rotation of the wind-actuated rotor urges gas (typically air) into a container for the storage of gas. When the wind-actuated rotor does not rotate (for example, when wind is light) gas may be released from the container to the pocket-carrying rotor. The container may, for example, be provided by a tower on which the wind-actuated rotor is mounted. The apparatus may therefore be operable in a first operating condition in which the wind-actuated rotor is rotated by wind and a second operating condition in which the pocket-carrying rotor (i.e. not the wind-actuated rotor) is rotated by gas delivered to the pocket-carrying rotor. The apparatus would typically operate in one of the first and second operating conditions at any given moment in time. Such an apparatus provides electricity generation when a wind is blowing (as a result of the wind-actuated rotor being rotated by the wind) and when the wind is not blowing (as a result of rotation of the pocket-carrying rotor caused by gas being emitted from the container).

The apparatus may be arranged such that in the absence of a wind of a given speed, the apparatus is arranged to operate in the second operating condition.

The apparatus may use wave action to generate power. For example, as mentioned above, the apparatus may comprise a float operable, when subjected to wave action, to generate power. The float may form part of a rocker mechanism, the rocking of which under the influence of waves generates power.

The float may be coupled to an electrical generator so that movement of the float generates power. Such an apparatus may be operable in a first operating condition in which, in use, power is generated by the rocker mechanism and in a second operation condition in which, in use, power of generated by rotation of the pocket-carrying rotor.

As previously indicated, the apparatus may comprise a container for the storage of liquid and a means of heating the liquid to generate gas. The liquid may be a low boiling point liquid, such as pentane or diethyl ether. The means for heating the liquid may comprise a reflector arranged to heat the liquid. The reflector may be arranged to heat a conductor, at least part of which is in thermal contact in the liquid. The reflector and the part of the conductor which receives radiation reflected from the reflector may be located externally of the container for the storage of liquid. A further part of the conductor may be located inside the container for the storage of liquid.

The means for heating the liquid may comprise a heat sink surface, for example, of a piece of machinery.

The apparatus of the present invention may comprise an expandable container for the storage of gas. The container preferably expands on heating and contracts on cooling. The apparatus may be arranged so that when the pressure in the container is greater than a predetermined pressure (typically 1 atmosphere), gas is delivered by virtue of the pressure in the container to the pocket-carrying rotor. The apparatus may further be arranged so that when the pressure in the container is less than a predetermined pressure (typically 1 atmosphere), the low pressure in the container draws gas to the pocket-carrying rotor. This may be achieved, for example, if the pocket-carrying rotor is located in an enclosure and the apparatus is provided with a valve operable by a pressure differential across the valve to admit gas into the enclosure.

The apparatus of the present invention may comprise an enclosure for the pocket-carrying rotor.

In accordance with a second aspect of the present invention, there is provided a rotor suitable for use in the apparatus of the first aspect of the present invention.

In accordance with a third aspect of the present invention, there is provided a method for generating power comprising the steps of:
(i) Providing a rotor, at least part of which is immersed in a liquid; and
(ii) Passing gas through the liquid and into contact with the rotor, the gas causing the rotor to rotate.

The method of the present invention provides a way of generating power (in particular, electrical power) from low pressure gas.

The gas is preferably air and the liquid is preferably water.

Step (ii) may comprise passing gas through the liquid from below the rotor.

Step (ii) may comprise using the buoyancy of the gas to turn the rotor. This allows gas to be bubbled onto the rotor, the natural buoyancy of the gas causing it to rise into contact with the rotor.

The rotor may be provided with a plurality of pockets for receiving gas.

Step (ii) may comprise accumulating a volume of gas in at least one pocket, and may preferably comprise accumulating a volume of gas in at least two pockets.

The rotor may be provided with from 3 to 10 pockets, preferably from 4 to 9 pockets, more preferably from 5 to 8 pockets and further more preferably 7 or 8 pockets. It has been found that 7 pockets have proved to be the most effective.

Gas may be generated by heating the liquid, preferably locally.

Gas may be passed to the rotor through the liquid by use of a negative pressure (for example, by providing the rotor in an enclosure and reducing the pressure in said enclosure to less than ambient pressure, and providing a valve operable to admit gas into said enclosure when ambient pressure is greater than the pressure in said enclosure).

Gas may be passed to the rotor through the liquid by use of a positive pressure.

It is preferred that the rotor is provided with a plurality of pockets for receiving gas. Step (ii) may comprise accumulating a volume of gas in at least one pocket. It is preferred that step (ii) may comprise accumulating a volume of gas in at least two pockets. This is especially preferred when one is trying to initiate rotation of the rotor (i.e. when the static inertia is at its greatest). Typically, a volume of gas may accumulate in one or more pockets prior to rotation (a certain volume of gas needing to accumulate in order to cause rotation).

Step (ii) may comprise using the buoyancy of the gas (as opposed to the discharge velocity of the gas) to turn the rotor.

The method may further comprise providing a container for the storage of gas. The gas may be released from the container to the rotor. The gas may be stored at any appropriate pressure, but may optionally be stored at a pressure of no more than 10 atmospheres, preferably no more than 5 atmospheres, more preferably no more than 3 atmospheres and further more preferably no more than 2 atmospheres.

The method may comprise providing a gas pump for supplying gas to said container. The gas pump may optionally be actuated by movement of liquid. For example, the gas pump may be actuated by a flow of liquid or a rising level of liquid (for example, waves or a rising level of liquid in a cavity). The method may comprise providing an actuator which actuates the gas pump, preferably in response to the movement of liquid. The actuator may comprise said rotor, for example. In this case, liquid flow causes rotation of said rotor which actuates said gas pump. The actuator may comprise one or more floats, for example. In this case, movement of said one or more floats (for example, in response to the passing of a wave) actuates the gas pump.

The method may comprise providing a generator associated with the rotor such that rotation of the rotor causes generation of electricity by said generator.

The method may comprise operating at a first point in time in a first operating condition which optionally comprises rotation of the rotor (but not being rotated by gas being passed to the rotor) and operating at a second point in time in a second operating condition in which the rotor is rotated by gas passed to said rotor.

If the rotor rotates in the first operating condition, then such rotation may be caused by a flow of liquid, such as tidal flow, or flow of liquid under the influence of gravity.

If the rotor does not rotate in the first operating condition, the generation of power in the first operating condition may be effected by wind power or wave motion.

The method may comprise operating in the second operating condition in the absence of sufficient stimulus for operation in the first operating condition (for example, in light winds, poor wave conditions or on a tidal slack water). For example, if operation in the first operating condition was dependent on tidal flow, in the event that tidal flow velocity fell below a certain value, then gas may be provided to the rotor so as to operate in the second operating condition.

Operation in the first operating condition may urge gas into a container for the storage of gas. The gas so stored may then be released to cause rotation of the rotor. For example, in the first operating condition, a wind-powered generating means (such as a wind turbine) may be used to both generate electricity and pump gas into a container which may then be used to provide gas to the rotor. Alternatively, a flow of liquid (such as a tidal flow) may cause rotation of the rotor in a first operating condition, the rotation of the rotor pumping gas into a container which may then be used to provide gas to the rotor.

The method of the present invention may comprise, at a first point in time, passing gas through the liquid and into contact with the rotor, the gas causing the rotor to rotate, and, at a second point in time, subjecting the rotor to a flow of liquid, the flow of liquid causing the rotor to rotate. At the second point in time, gas will not generally be passed into contact with the rotor. Likewise, at the first point in time, the rotor will generally not be subjected to a liquid flow which would cause it to rotate.

Flow of liquid may typically be provided by a water current, such as a tidal current. When the tide is flowing, the movement of the water will cause the rotor to rotate. When the tide is slack, gas will be passed into contact with the rotor, and the gas will cause the rotor to rotate.

Rotation of the rotor caused by flow of liquid may cause gas to be delivered to a container for the storage of gas (if provided). The flow of liquid therefore provides energy to compress the gas which can then be used to turn the rotor in the absence of a liquid flow.

It is preferred that release of gas in step (ii) is actuated by the liquid flow falling below a certain level. For example, a decrease in the amount of liquid flow impinging on the rotor may cause the rotor to fall in the liquid. The fall of the rotor may actuate the release of gas in step (ii). The rotor may be attached to a rotor carrier and the rotor carrier may be mounted so that movement of the rotor carrier into a particular position causes the release of gas in step (iii).

The rotor may comprise a plurality of blades. The blades may assist in the formation of pockets for the receipt of gas. The blades may be concave. For example, a blade may be curved to receive gas. One or more of the blades may be elongate. One or more of the blades may be hemi-cylindrical.

The rotor may comprise 3 to 10 blades, preferably 4 to 9 blades, more preferably 5 to 8 blades and further more preferably 7 or 8 blades. It has been found that 7 blades have proved to be the most effective.

The method of the third aspect of the present invention may use the apparatus of the first aspect of the present invention and/or the rotor of the second aspect of the present invention.

The invention will now be described by way of example only with reference to the following figures, of which:

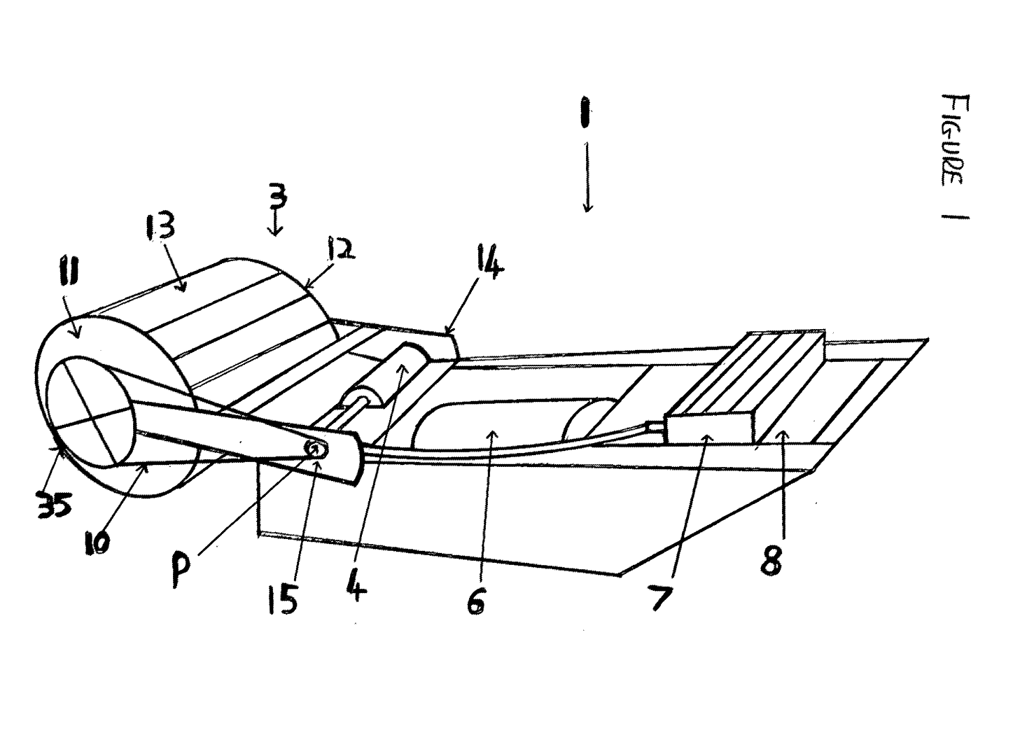

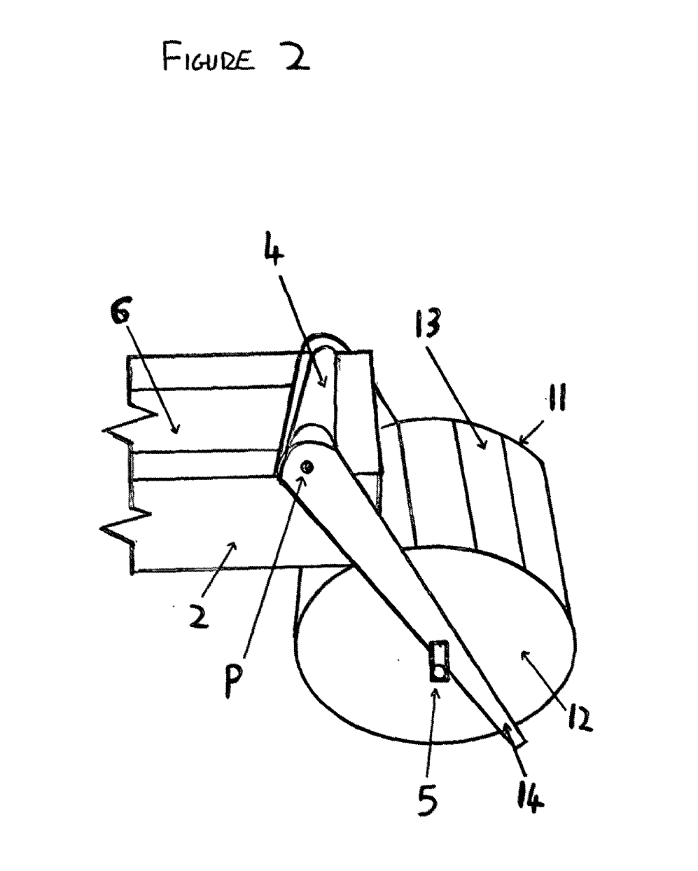

FIG. 1 is a perspective view of a first example of an embodiment of an apparatus in accordance with the first aspect of the present invention;

FIG. 2 is a detailed view of a portion of the apparatus of FIG. 1;

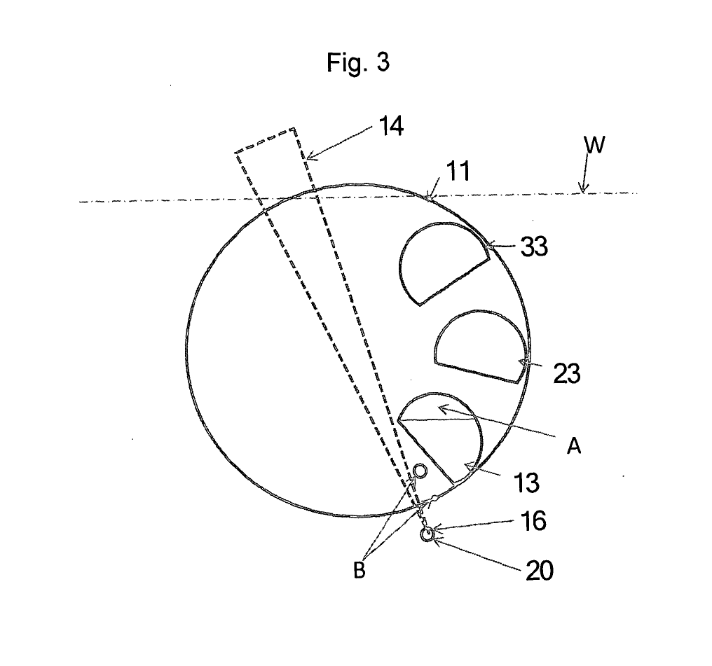

FIG. 3 is a schematic cross-sectional view of a portion of the apparatus of FIG. 1 showing the relationship between the gas outlet and the rotor;

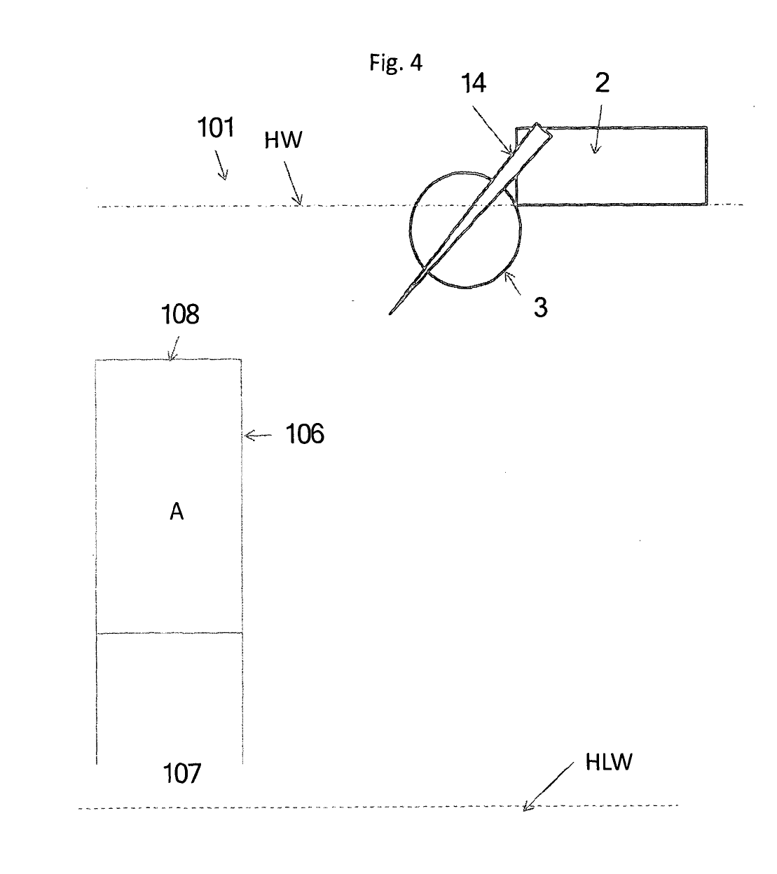

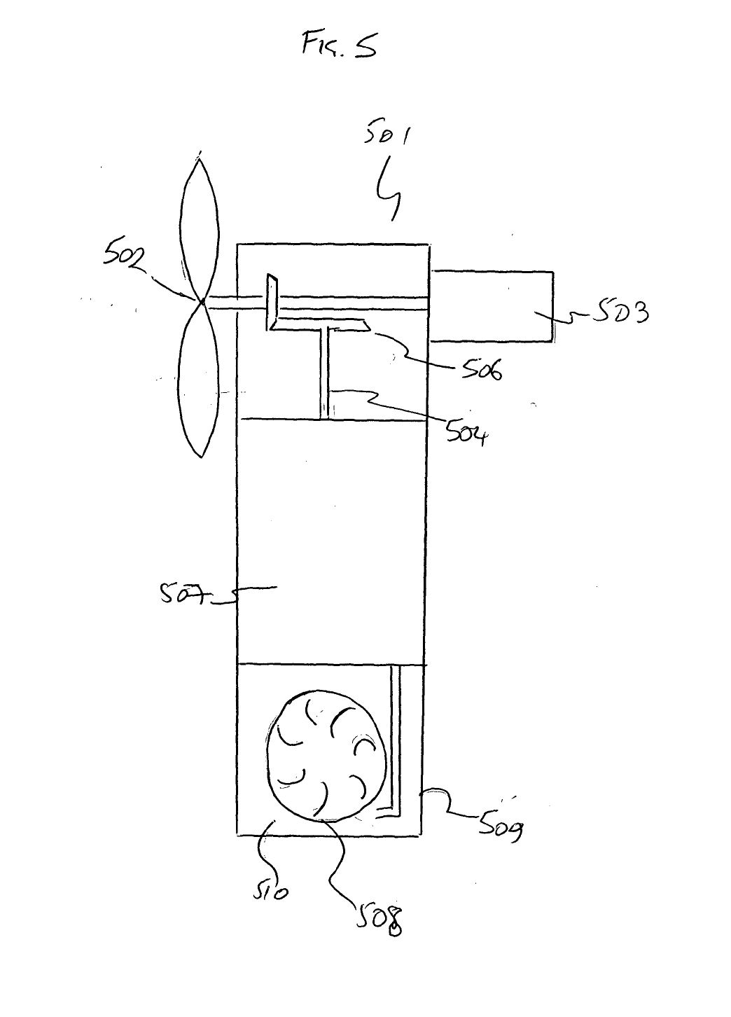

FIG. 4 is a schematic representation of a second example of an embodiment of an apparatus in accordance with the first aspect of the present invention;

FIG. 5 is a schematic representation of a further example of an embodiment of an apparatus in accordance with the first aspect of the present invention;

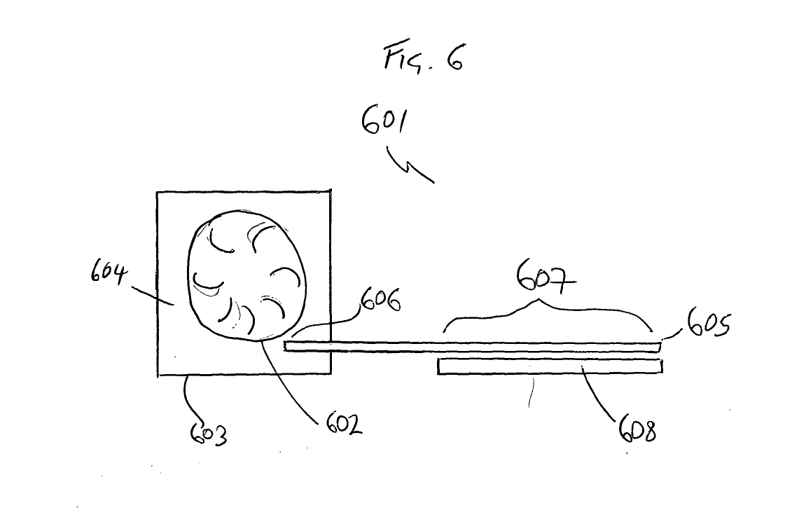

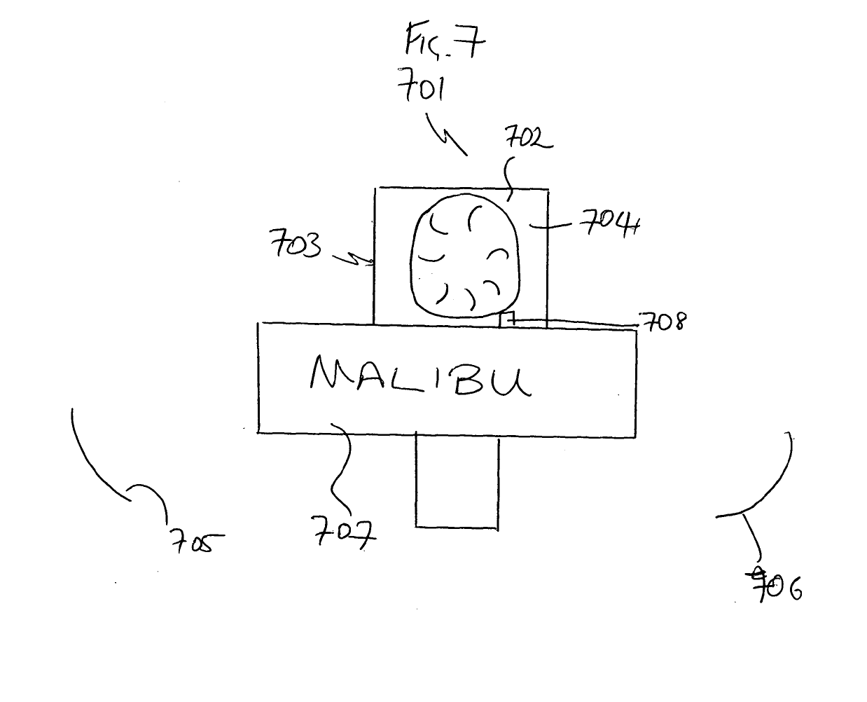

FIG. 6 is a schematic representation of another example of an embodiment of an apparatus in accordance with the first aspect of the present invention;

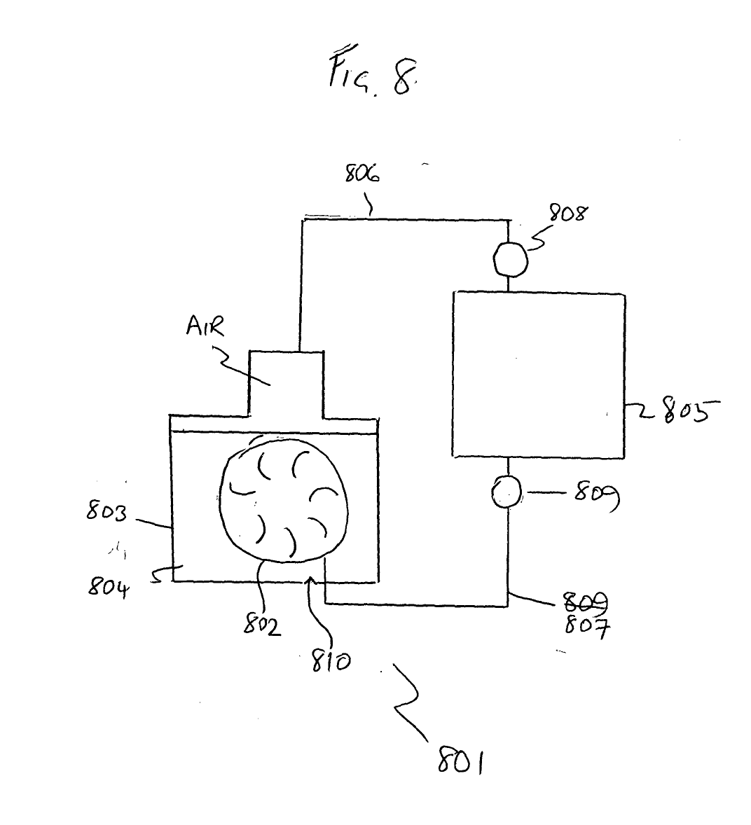

FIG. 7 is a schematic representation of yet another example of an embodiment of an apparatus in accordance with the first aspect of the present invention;

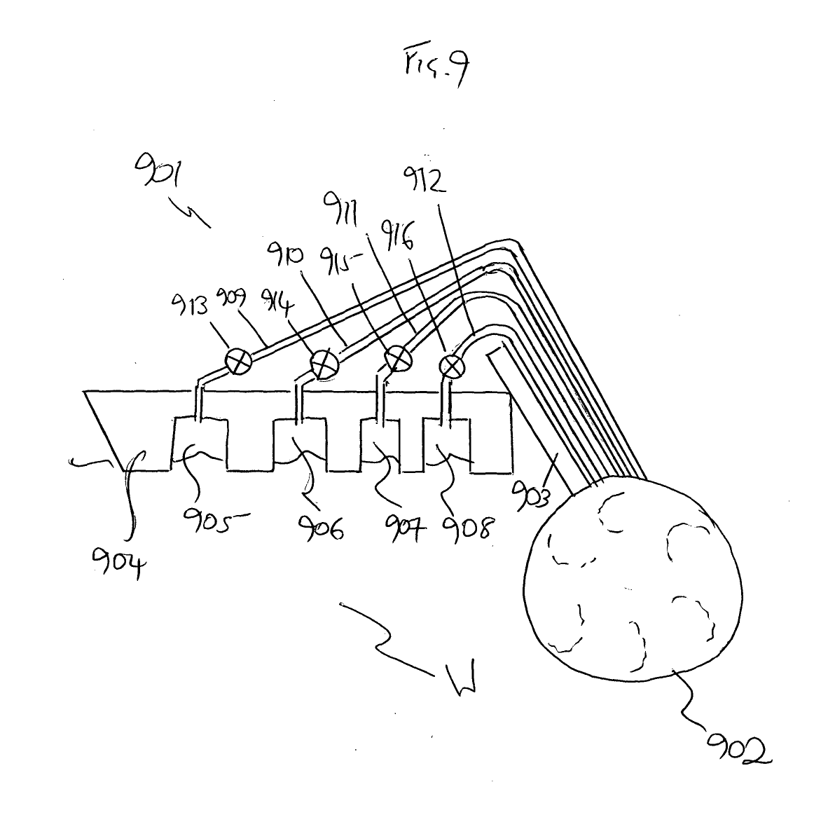

FIG. 8 is a schematic representation of a further example of an embodiment of an apparatus in accordance with the first aspect of the present invention;

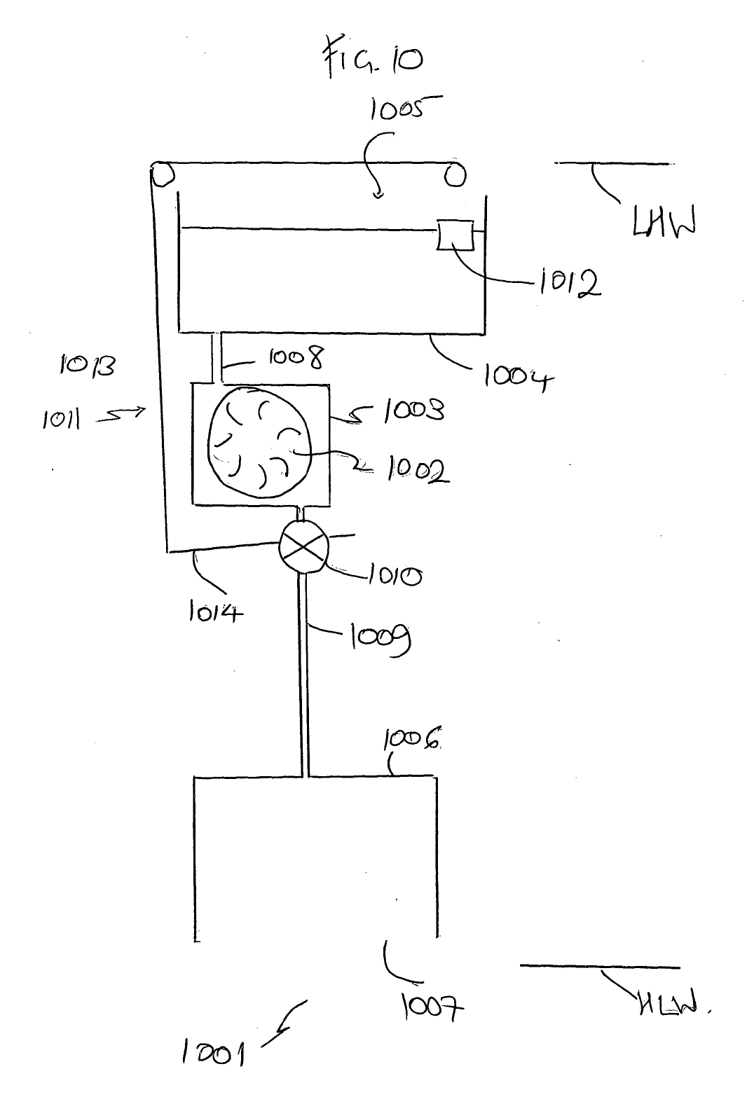

FIG. 9 is a schematic representation of a further example of an embodiment of an apparatus in accordance with the first aspect of the present invention;

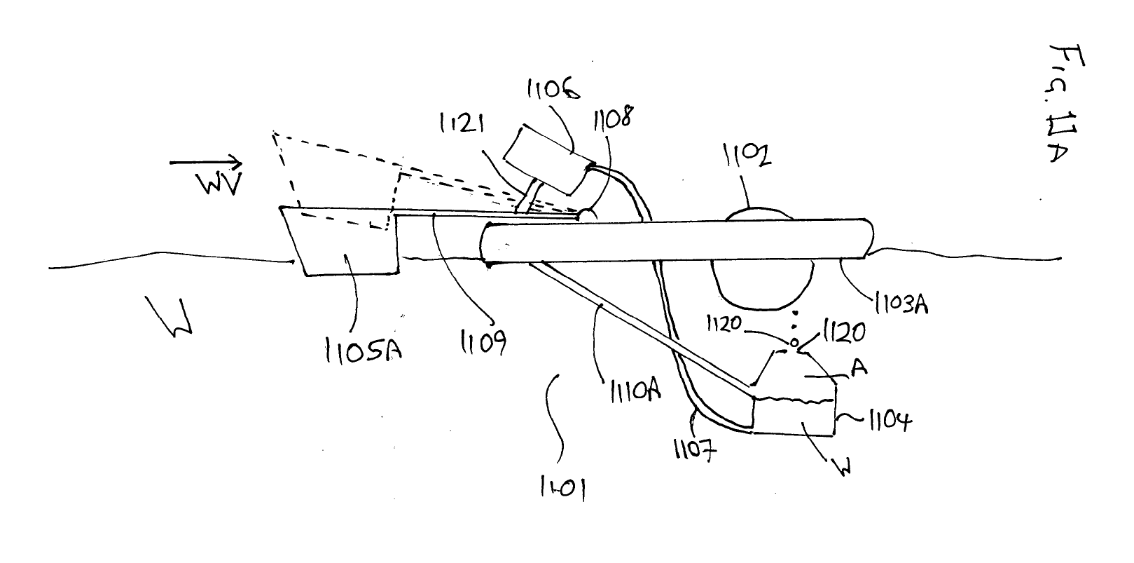

FIG. 10 is a schematic representation of yet another example of an embodiment of an apparatus in accordance with the first aspect of the present invention;

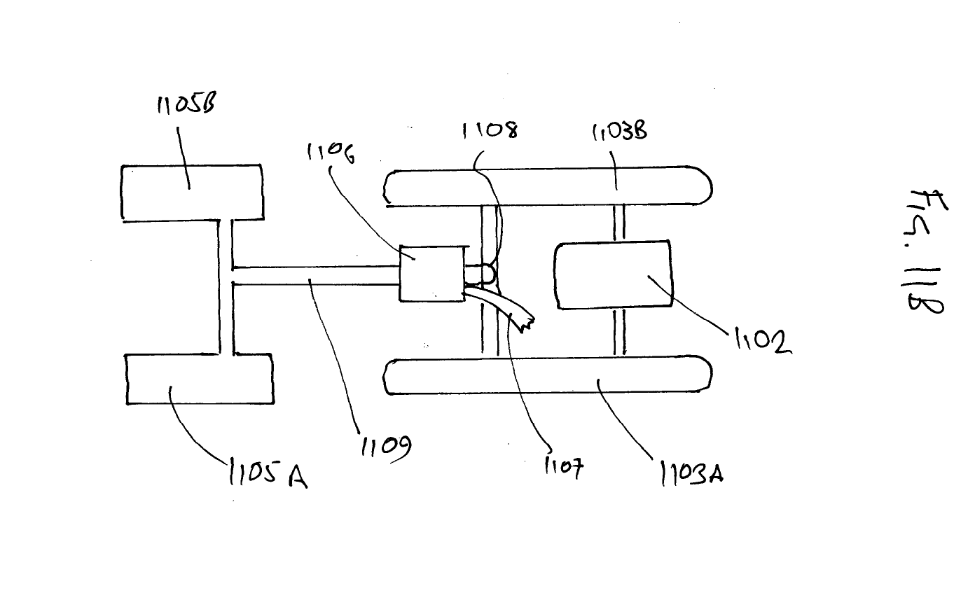

FIG. 11A is a schematic side view (with part in cross-section) of a further example of an apparatus in accordance with the first aspect of the present invention;

FIG. 11B is a schematic plan view of the apparatus of FIG. 11A.

A first example of an embodiment of an apparatus in accordance with the first aspect of the present invention is now described with reference to FIGS. 1, 2 and 3. The apparatus is denoted generally by reference numeral 1 and comprises a rotor 3 attached to a rotor carrier 14 which is pivotally attached at point P to platform 2. The apparatus is designed to operate in a tidal aquatic environment and, to facilitate this, platform 2 floats. The rotor 3 comprises seven blades (only one of which is labelled, 13) disposed between end plates 11, 12. The blades 13 and plates 11, 12 are typically made from any substantially rigid material, such as a sutiable plastics material (e.g. polycarbonate), a metal and fibreglass. Plastics and fibreglass are preferred because they do not degenerate in saltwater conditions as quickly as some metals. The rotor 3 is mounted to rotate, rotation of the rotor causing rotation of gear 35, movement of chain 10 and therefore rotation of the rotatable gear 15. In the present apparatus, the ratio of the number of teeth on gear 35 to gear 15 is about 5:1. Rotation of the rotatable gear 15 causes rotation of the rotatable rotor of dynamo 4, thus causing the generation of electricity. Dynamo 4 is a commercially-available dynamo, in this case a permanent magnet generator (often known as a PMG). In one mode of operation, the rotor is partially immerged in water and moving water (as part of the tidal flow) impinges on the blades of the rotor 3, thus causing rotation of the rotor 3 which generates electricity. Rotation of rotor 3 also causes actuation of compressor 5 (see FIG. 2). The compressor is a small positive displacement compressor of the piston type (in this case, a 12V air compressor scavenged from a tyre inflator). Operation of the compressor 5 causes air to be provided to an air container 6 through a conduit (not labelled). In this case, the air container 6 is a cylinder suitable for containing high pressure gases (in this case, a medical air cylinder). The air container 6 is provided with a pressure limiter (not shown) which limits the pressure in the container to a maximum of 2 atmospheres, although those skilled in the art will realise that other pressures may be used.

Rotation of rotor 3 causes it to lift in the water, as well as to rotate. Furthermore, the apparatus may be provided with a fin (not shown) at the end of the rotor carrier which assists in raising the rotor in the water when the water flows. Furthermore, the apparatus may be provided with one or more inflatable and deflatable floats associated with the rotor carrier to help the rotor in the water. The floats are typically inflated by flow actuated valves which fill the floats with air (preferably supplied from air container 6). When the flow of liquid is above a certain level, the flow actuated valves are actuated so as to admit air into the floats. When the flow of liquid decreases (such as when the tidal flow decreases) the rotor 3 spins less quickly and drops through the water. The apparatus 1 is arranged such that on slack tide (when there is no rotation of the rotor 3 caused by water movement), rotor 3 drops to the position shown in FIG. 2. When the rotor 3 reaches this position, release of the gas stored in container 6 is activated as is now described. When the rotor reaches a certain position, a valve (not shown) is operated, releasing air from the container.

Gas is emitted from container 6 and then passes through a convoluted conduit 7 which is exposed to heating by radiation reflected by a mirrored surface 8. The convoluted conduit is provided by a vehicle radiator. The warmed air then passes via a conduit to outlet 16. The arrangement of the outlet 16 in relation to the rotor 3 is shown in FIG. 3. The water level is shown by the dashed line labelled “W”. Air passes to a conduit 20 part of which is located at the end of rotor carrier 14. Conduit 20 extends to approximately midway between end plates 11 and 12. Outlet 16 is provided at the end of conduit 20. Outlet 20 is positioned to emit gas (generally in the form of bubbles “B”) into the region provided by hemispherical blade 13 and end plates 11 and 12. The size of the outlet orifice through which the gas is emitted is selected so that gas is emitted at a desired rate. For example, a larger outlet orifice will give a higher gas discharge rate. The region bounded by the blade 13 and the end plates defines a pocket for the collection of gas. Air (labelled “A”) displaces water in the pocket and once sufficient air has entered the pocket, the buoyancy of the air collected therein causes the rotor 3 to turn. This rotation of the rotor generated electricity. Rotation of the rotor also causes the rotor 3 to rise in the water.

The apparatus may be arranged so that in the event that the rotor rotates too quickly as a result of gas release, then the resulting rise in the water of the rotor 3 will cause the gas supply to the outlet 16 to be cut-off, thereby providing a negative feedback loop for controlling the release of gas from the container.

The imaginary base of each hemi-cylindrical blade 13, 23, 33 points towards the rotational axis of the rotor as shown in FIG. 3. The blades are equally angularly spaced about the rotor 3. In the present case, the rotor has a diameter of about 18″. Each blade is about 10″ in length and is about 4″ across (the blades were cut from a drainpipe having a diameter of about 4″).

Those skilled in the art will realise that in FIG. 3, only some and not all of the blades of the rotor are shown. Several blades have been omitted for the purpose of clarity.

An alternative example of an embodiment of an apparatus in accordance with the present invention is shown in FIG. 4. The apparatus is denoted generally by reference numeral 101 and comprises the same rotor 3 as described above in relation to the apparatus of FIGS. 1 to 3. The rotor 3 is attached to a rotor support 14 which is essentially the same as that described above in relation to FIGS. 1 to 3. The rotor support 14 is pivotally attached to a floating platform 2. The gas container is not in this example mounted on the platform. The gas container is generally denoted in the present example by reference numeral 106. The rotor 3 is driven by liquid flow as described above in relation to the apparatus of FIGS. 1, 2 and 3. However, the apparatus 101 does not include a compressor for filling a container with air. The present example uses the tides to fill the container 106 with air and then compress the air. The container has an open end 107 lower than its closed end 108. Open end 107 is above the highest low tide mark (“HLW”), therefore ensuring that at any low tide, the container will fill with air. On the rising tide, the water will surround the container 106 and pressurise the air (“A”) trapped in container 106. The pressurised air may be fed to an outlet (not shown) adjacent to the rotor 3 during periods of high slack tide as described in relation to the apparatus of FIGS. 1 to 3. The height of the water at high tide is indicated by “HW”. When the tidal flow drops below a certain level, the apparatus is arranged to release air from the container 106 to drive the rotor 3.

The apparatuses of FIGS. 1 to 4 generate power from tidal flow, with the tidal flow causing rotation of the rotor when the rotor is not being operated by gas being passed to the rotor. The rotor does not have to be used as the primary source of power, as can be seen from the apparatus of FIG. 5. FIG. 5 shows a further example of an embodiment of an apparatus according to the first aspect of the present invention. The apparatus is denoted generally by reference numeral 501. The apparatus 501 comprises a wind-driven rotor 502 coupled to a generator 503, wherein rotation of the wind-driven rotor causes the generation of electricity by the generator. Rotation of the wind-driven rotor 502 also causes rotation of a shaft 504 via a gearing arrangement 506, rotation of the shaft 504 causing air to be supplied to a container 507. When the wind-driven rotor is inoperable (for example, in the event of low wind speeds), air stored in the container 507 is released using a suitable valve arrangement and outlet (not shown) as bubbles into an enclosure 509 full of liquid 510. The pocket-carrying rotor 508 is essentially the same as that described above in relation to the apparatuses of FIGS. 1 to 4, and is mounted in the enclosure 509. Bubbles collect in one or more of the pockets of the pocket-carrying rotor 508 and cause the rotor to rotate, the pocket-carrying rotor 508 being coupled to the generator 503 so that rotation of the pocket-carrying rotor 508 causes generation of electricity by the generator 503.

A further example of an embodiment of an apparatus in accordance with the first aspect of the present invention is shown in FIG. 6. The apparatus is denoted generally by reference numeral 601. The apparatus comprises a pocket-carrying rotor 602 which is essentially the same as that described above in relation to the apparatuses of FIGS. 1 to 5. The rotor 602 is housed in an enclosure 603 containing a liquid 604. A copper rod 605 extends into the enclosure, the end 606 of the rod being located below the rotor 602. A portion 607 of the copper rod is located approximately at the focus of a parabolic reflector 608. Radiation incident on the reflector 608 is reflected to the portion 607 of the rod, thereby heating the portion 607 of the rod. The rod is conductive and so heating of the portion 607 causes heating of the rest of the rod, including that portion of the rod in the enclosure 603. The hot rod heats the liquid 604 and causes evaporation of the liquid in the immediate vicinity of the end 606, thus forming bubbles. The bubbles collect in the pockets of the rotor and cause rotation in a manner similar to that described above in relation to the apparatuses of FIGS. 1 to 5. The rotor is coupled to a generator (not shown) so that rotation of the rotor causes generation of electricity.

A further example of an embodiment of an apparatus in accordance with the first aspect of the present invention is shown in FIG. 7. The apparatus is denoted generally by reference numeral 701 and comprises a pocket-carrying rotor 702 housed in an enclosure 703 full of a liquid 704. The pocket-carrying rotor is essentially the same as that described above in relation to the apparatuses of FIGS. 1 to 6. The apparatus further comprises two reflective lenses 705, 706 located so as to focus reflected light on a metal member 707. The metal member is thermally connected to a metal rod 708 located below the rotor 702. The metal member and rod become heated as a result of the radiation reflected onto the metal member by the lenses 705, 706. Heating of the rod causes boiling of the liquid 704, thereby generating bubbles immediately below the rotor. The bubbles collect in one or more pockets of the rotor and cause it to rotate as previously described. The metal member 707 in the present apparatus may also convey information and thereby act as a sign.

The precise nature of the liquid 604, 704 will depend very much on the expected environmental conditions. For example, in certain conditions liquids having a very low boiling point (e.g. pentane, diethyl ether) may be used, but in certain environments the health and safety risks associated with the use of such liquids may render their use inadvisable.

Yet another example of an apparatus in accordance with the present invention is shown in FIG. 8. The apparatus is denoted generally by reference numeral 801 and comprises a rotor 802 housed within an enclosure 803 provided with a liquid 804. The rotor 802 is essentially the same as the rotor described above in relation to the apparatuses of FIGS. 1 to 7. The apparatus 801 further comprises an expandable reservoir 805 for the containment of gas. The reservoir is in the form of a flexible skin (such as a rubber skin) over a supporting frame. Conduits 806, 807 provide gaseous communication between the enclosure 803 and reservoir 805. Valves 808, 809 are provided to control gaseous communication between the reservoir and the enclosure. An enclosure valve 810 (the operation of which is described later) is also provided.

The operation of apparatus 801 will now be described. At a certain time of the day (typically in the afternoon), the air in the reservoir 805 is at a high temperature as a results of environmental conditions. The high temperature of the air in reservoir 805 will cause an increase in the volume of the air in the reservoir and the reservoir will swell. Valve 809 will then be opened to release air from the reservoir, through conduit 807 to be released into liquid 804 below the rotor 802. The air bubbles so released will collect in one or more pockets of rotor 802 and cause rotation of the rotor 802 and therefore generation of electricity by operation of a generator (not shown). Once the desired amount of air has been released from reservoir 805, valve 809 is closed. Throughout this mode of operation, valve 808 is closed.

Cooling of the air in the reservoir takes place as the environment around the apparatus cools, for example, at night and the air in the reservoir contracts thereby leading to shrinkage of the reservoir. In the early hours of the morning, the pressure in the reservoir will typically be negative (i.e. less than ambient pressure). When a suitable pressure in the reservoir has been attained, valve 808 is opened. The negative pressure in reservoir 805 causes air to be drawn through enclosure valve 810. This air is collected in one or more pockets of the rotor, and thus causes the rotor to rotate, thereby generating electricity. Enclosure valve 810 may be a slit valve, operable to prevent egress of liquid from the enclosure 803 and operable to permit ingress of air into the enclosure 803 when there is a suitable pressure differential across the valve 810.

A further example of an embodiment of an apparatus in accordance with the present invention is shown in FIG. 9. The apparatus is generally denoted by reference numeral 901, and comprises a pocket-carrying rotor 902 mounted on a rotor carrier 903 which is pivotally attached to a floating platform 904. The rotor 902 is essentially the same as the rotor described above in relation to the apparatuses of FIGS. 1 to 8. The floating platform 904 is provided with a plurality of openings, only four of which (905, 906, 907, 908) are shown for the purposes of clarity. When the platform 904 is in contact with the water (W) the openings 905, 906, 907, 908 form chambers containing air. When water enters the chambers (for example, as a result of wave action) or when the platform falls onto the water (once again, as a result of wave action) air in the chambers is urged through a respective conduit 909, 910, 911, 912 provided for each of the chambers, to the rotor 902. Each chamber 905, 906, 907, 908 is provided with a non-return valve 913, 914, 915, 916 (in this case, a flap-type valve) which allows air into the respective chamber to refill the chamber with air, but inhibits passage of air out of the chamber through the valve (the only way for the air to leave the chamber being via the respective conduit to the rotor) Each of the chambers, in combination with movement of the water, therefore acts as a pump. The air in each of the conduits 909, 910, 911, 912 passes to respective outlets (not shown) which are located below rotor 902. Air passes from the outlets into the water, to be collected in one or more of the pockets of the rotor 902, thereby causing rotation of the rotor and operation of a generator (not shown) as described above in relation to the apparatuses of FIGS. 1 to 8.

Yet a further example of an apparatus in accordance with the present invention is shown in FIG. 10. The apparatus is denoted generally by reference numeral 1001. The apparatus comprises a rotor 1002 mounted in an enclosure 1003. The apparatus is provided with an upper chamber 1004 with an open upper end 1005, the open upper end 1005 being located slightly below the lowest high tide mark (LHW). The apparatus is further provided with a lower chamber 1006 with an open bottom 1007, the open bottom 1007 being located slightly above the highest low tide mark (HLW). The apparatus is further provided with conduits 1008, 1009 provided in the fluid flow path between the enclosure 1003 and the upper chamber and lower chamber respectively. The conduit 1009 is provided with a valve 1010. A mechanism denoted generally by reference numeral 1011 for controlling the operation of the valve 1010 is also provided. The operation of the apparatus will now be described, starting from low tide and assuming that the apparatus has just been installed.

At low tide, the level of the water is always below the open bottom 1007 of the lower chamber 1006, so air can enter the lower chamber. When the tide rises, the air in the lower chamber becomes compressed, but the valve 1010 (in a closed state) prevents air from passing from the lower chamber 1006 to the enclosure 1003 housing the rotor 1002. When the tide is high, upper chamber 1004 is full of water. Once the tide starts to fall, water may be passed from the upper chamber 1004 to the rotor 1002 via conduit 1008, thereby causing rotation of the rotor 1002, and operating of a generator (not shown). This also causes the level of water in the upper chamber 1004 to drop. A float 1012 is provided in the upper chamber, the position of the float depending on the level of the water. The float 1012 is connected via a wire 1013 to a pivotally mounted lever 1014. The pivotally mounted lever controls the operation of valve 1010. When the position of the float 1012 in the upper chamber 1004 reaches a predetermined level, the valve is operated (via the wire 1013 and lever 1014) into an open position. This permits the pressurised air in the lower chamber 1006 to enter the enclosure 1003. The conduit 1009 is arranged so that air is emitted therefrom to be collected in the pockets of the rotor 1002. The air causes rotation of the rotor, and thereby causes generation of electricity for as long as air is emitted from the lower chamber 1006.

A further example of an embodiment of an apparatus in accordance with the first aspect of the present invention is shown in FIGS. 11A and 11B. The apparatus, denoted generally by reference numeral 1101, is placed in water W and comprises a rotor 1102 which is essentially the same as that described above in relation to FIGS. 1 to 10. The rotor 1102 is mounted above a reservoir 1104 which is provided with an aperture 1120 for the release of air (A) from the reservoir 1104 into the pockets (not shown) provided in the rotor 1102. A valve (not shown) is associated with the aperture 1120 so that release of air from the reservoir 1104 may be controlled. For example, if a tide is running, the tidal movement of water may be used to turn the rotor 1102 to generate power. In this condition, one may close the valve associated with aperture 1120 so that air is not used to drive the rotor 1102. When the tide is not running or when the tide is slow, one may wish to open the valve so that air is used to drive the rotor 1102.

The apparatus is provided with two hulls 1103A, B which provide buoyancy to the apparatus.

Air is delivered to the reservoir 1104 by means of a pump. The pump comprises a pump chamber 1106 comprising a movable diaphragm and one-way flap valve (not shown), the pump chamber being in communication with the reservoir 1104 via a conduit 1107. The diaphragm is connected to an actuating member 1121 such that movement of the actuating member causes movement of the diaphragm. The actuating member 1121 is attached to an arm 1109 which is mounted at one end for pivotal movement at pivot 1108. The other end of the arm 1109 is connected to two floats 1105 A, B. A wave moving in the direction of arrow WV causes floats 1105A, B to move into an elevated position. This causes pivotal movement of the arm 1109 which causes movement of actuating member 1121. Movement of actuating member 1121 moves the pump chamber diaphragm, thereby displacing air past the one-way flap valve, through conduit 1107 into reservoir 1104.

In the apparatus of FIGS. 11A and 11B, air in reservoir 1104 may be transferred through conduit 1110A and stored in hulls 1103A, B.

The rotor of the apparatus of FIGS. 11A and 11B is arranged in a very similar manner to that on the apparatus of FIGS. 1, 2 and 3 in that as the rate of liquid flow drops, the rate of rotation of the rotor decreases and the rotor falls in the water. Once the rotor reaches a certain position, this actuates a valve to release air from the reservoir 1104 and floats 1105A, B, the air which is released turning the rotor and generating power.

Some of the examples of apparatus above have been found to be effective at converting certain types of motion which are not terribly effective at driving rotors (for example, wave motion) into motion which is more effective at turning rotors (for example, by using wave motion to pump air to a container for subsequent release to the rotor).

The apparatuses of FIGS. 1 to 11 show one particular arrangement of pockets. Other particular pocket arrangements are anticipated. For example, one could use more or fewer pockets. Also, the shape and size of the pockets could be different from the hemi-cylindrical shape shown

The arrangements of FIGS. 1 to 11 show two of the many ways in which pressurised gas may be stored for subsequent use. It is anticipated that other arrangements may be used. For example, one could store air in the hull of a boat, say in one or more hulls of a multi-hulled vessel, such as a catamaran or trimaran.

The apparatuses of FIGS. 1 to 11 show the generator being driven using a gear-and-chain arrangement. Those skilled in the art will realise that alternative arrangements may be used to couple the rotor to a generator, for example, the use of a drive shaft. Furthermore, the rotor could be an integral part of a generator. For example, the rotor could be provided with magnets, and a rotor housing or rotor carrier could be provided with other necessary components for the generation of electricity. The rotation of the rotor would in this case cause movement of the magnets, and therefore generation of electricity.

The apparatuses of FIGS. 1 to 11 are arranged to generate electrical energy. Whilst it is convenient to generate and transmit electrical energy, the method and apparatus of the present invention may be used to generate other forms of energy.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. A method for generating power comprising the steps of:
(i) Providing a rotor, at least part of which is immersed in a liquid; and
(ii) Passing gas through the liquid and into contact with the rotor, the gas causing the rotor to rotate.

2. A method according to claim 1 comprising operating at a first point in time in a first operating condition in which rotation of the rotor is caused by a flow of liquid but not being caused by gas being passed to the rotor and operating at a second point in time in a second operating condition in which the rotor is rotated by gas passed to said rotor.

3. A method according to claim 2, comprising operating in the second operating condition in the absence of sufficient stimulus for operation in the first operating condition.

4. A method according to claim 2 wherein operation in the first operating condition urges gas into a container for the storage of gas, the gas being released to effect operation in the second operating condition.

5.-7. (canceled)

8. A method according to claim 1 wherein the gas is generated by heating the liquid.

9. (canceled)

10. A method according to claim 1, wherein gas is passed to the rotor by use of a positive pressure.

11. A method according to claim 1, wherein the rotor is provided with a plurality of pockets for receiving gas, step (ii) comprising accumulating a volume of gas in at least one pocket.

12.-13. (canceled)

14. A method according to claim 1 wherein step (ii) comprises using the buoyancy of the gas to turn the rotor.

15. A method according to claim 1 comprising providing a container for the storage of gas for subsequent release to the rotor, and wherein the gas is stored at a pressure of no more than 3 atmospheres.

16. (canceled)

17. A method according to claim 1 comprising operating at a first point in time in a power-generating first operating condition in which the rotor does not rotate, and operating at a second point in time in a second operating condition in which the rotor is rotated by gas passed to said rotor.

18. A method according to claim 17, comprising operating in the second operating condition in the absence of sufficient stimulus for operation in the first operating condition.

19. A method according to claim 17 wherein operation in the first operating condition urges gas into a container for the storage of gas, the gas being released to effect operation in the second operating condition.

20. An apparatus to generate power from a gas, the apparatus comprising:
a rotor for at least partial immersion in a liquid,
the rotor being provided with a plurality of pockets for receiving gas, the rotor being operable to be rotated by the gas received in one or more of said pockets.

21. An apparatus according to claim 20 wherein the apparatus is operable in a first operating condition in which the pocket-carrying rotor is rotated by a flow of liquid, and in a second operating condition in which the rotor is rotated by gas delivered to the pocket-carrying rotor.

22. An apparatus according to claim 21 arranged so that in the absence of sufficient stimulus for operation in the first operating condition, the apparatus is arranged to operate in the second operating condition.

23. An apparatus according to claim 22 comprising a container for the storage of gas, the apparatus being operable so that in the absence of a liquid flow of a given magnitude, the rotor assumes a certain position or orientation, the assumption of that certain position or orientation actuating release of gas from the container.

24. An apparatus according to claim 21 wherein operation in the first operating condition urges gas into a container for the storage of gas.

25. An apparatus according to claim 24 comprising a compressor for urging gas into the container for the storage of gas.

26. An apparatus according to claim 20 comprising a means for supplying gas to said rotor, the means for supplying gas comprises one or more of a container for the storage of gas, a container for the storage of liquid and a heater for heating the liquid into a gaseous state, a valve for introducing gas to the rotor and a gas pump.

27.-35. (canceled)

36. An apparatus according to claim 20 wherein the apparatus is operable in a first operating condition which optionally comprises rotation of the pocket-carrying rotor and a second operating condition in which the rotor is rotated by gas delivered to the pocket-carrying rotor, the apparatus being provided with a primary power generator for generating power in the first operating condition.

37. An apparatus according to claim 36 arranged so that in the absence of sufficient stimulus for operation in the first operating condition, the apparatus is arranged to operate in the second operating condition.

38. An apparatus in accordance with claim 36 comprising a container for the storage of gas, wherein operation in the first operating condition urges gas into the container for subsequent release to cause rotation of the pocket-carrying rotor.
